(19) United States
(12) Patent Application Publication
(10) Pub. No.: US 2024/0145729 A1
(43) Pub. Date: May 2, 2024

(54) Single-Sided Electrode, Electrode Assembly Including Same, and Single-Sided Electrode Manufacturing Apparatus

(71) Applicant: LG Energy Solution, Ltd., Seoul (KR)

(72) Inventors: Hyeok Jeong, Daejeon (KR); Seokhoon Jang, Daejeon (KR); Su Taek Jung, Daejeon (KR); Won Pill Hwang, Daejeon (KR); Sangho Bae, Daejeon (KR)

(73) Assignee: LG Energy Solution, Ltd., Seoul (KR)

(21) Appl. No.: 18/279,681

(22) PCT Filed: Nov. 22, 2022
(86) PCT No.: PCT/KR2022/018528

§ 371 Date: Sep. 1, 2023

(30) Foreign Application Priority Data
Nov. 22, 2021 (KR) 10-2021-0161634
Nov. 22, 2022 (KR) 10-2022-0157376

(51) Int. Cl. H01M 4/66; H01M 4/04; H01M 4/36

(52) U.S. Cl. CPC H01M 4/667; H01M 4/0404; H01M 4/0435; H01M 4/366

(57) ABSTRACT

The present disclosure provides a single-sided electrode comprising: an electrode current collector; an active material layer located on one surface of the electrode current collector; and a coating layer located on the other surface of the electrode current collector, wherein a thickness of the coating layer is smaller than a thickness of the active material layer.

### TECHNICAL FIELD

### Cross Citation with Related Application(s)

This application claims the benefit of Korean Patent Application No. 10-2021-0161634 filed on Nov. 22, 2021 and Korean Patent Application No. 10-2022-0157376 filed on Nov. 22, 2022 in the Korean Intellectual Property Office, the entire contents of which are incorporated herein by reference.

The present disclosure relates to a single-sided electrode, an electrode assembly including the same, and a single-sided electrode manufacturing apparatus, and more specifically, to a single-sided electrode having controlled curl, an electrode assembly including the same, and a single-sided electrode manufacturing apparatus.

### BACKGROUND

With the technology development and increased demand for mobile devices, demand for secondary batteries as energy sources has been rapidly increasing. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Based on the shape of a battery case, a secondary battery is classified into a cylindrical battery where an electrode assembly is mounted in a cylindrical metal can, a prismatic battery where an electrode assembly is mounted in a prismatic metal can, and a pouch-type battery where an electrode assembly is mounted into a pouch type case formed of an aluminum laminate sheet. Here, the electrode assembly mounted in the battery case is an electricity-generating device enabling charge and discharge that has a structure of a cathode, an anode, and a separator interposed between the cathode and the anode, and is divided into a jelly-roll type in which an electrode assembly including a separator interposed between the cathode and the anode, each made of an active material-coated long sheet, is rolled, and a stack-type in which a plurality of cathodes and a plurality of anodes are stacked in this order in state where a separator is interposed between the cathode and the anode.

Among them, in particular, a pouch-type battery having a structure in which a stack-type or stack/folding-type electrode assembly is mounted in a pouch-type battery case of an aluminum laminate sheet is gradually increasing in its usage amount due to low manufacturing cost, small weight, easy deformation, and the like.

Here, in the case of a stack-type electrode assembly, it is common to manufacture a unit cell in advance and then stack the unit cell by a plurality of numbers. More specifically, the unit cell can apply heat and pressure through a laminating device in a state in which the separator-anode-separator-cathode are alternately laminated in this order, so that each component can be fixed to each other.

However, a stack-type electrode assembly is generally a half-cell to secure cell safety and has a structure in which an anode is stacked on the uppermost stage. However, in this case, there is a problem in that energy density is lowered due to the half cell. Accordingly, there is a need to develop an electrode assembly that can secure cell stability while increasing energy density by omitting arrangement of a half-cell on the uppermost stage in the stack-type electrode assembly.

### DETAILED DESCRIPTION OF THE INVENTION

### Technical Problem

It is an object of the present disclosure to provide a single-sided electrode having controlled curl, an electrode assembly including the same, and single-sided electrode manufacturing method.

The objects of the present disclosure are not limited to the aforementioned objects, and other objects which are not mentioned herein should be clearly understood by those skilled in the art from the following detailed description and the accompanying drawings.

### Technical Solution

According to one embodiment of the present disclosure, there is provided a single-sided electrode comprising: an electrode current collector; an active material layer located on one surface of the electrode current collector; and a coating layer located on the other surface of the electrode current collector, wherein a thickness of the coating layer is smaller than a thickness of the active material layer.

Specifically, the thickness of the coating layer may be 26% or more and 49% or less of the thickness of the active material layer.

Wherein, the coating layer may be made from a coating composition which comprises,
a) at least one acrylate selected from the group consisting of a monofunctional acrylate, a bifunctional acrylate, and a trifunctional acrylate, and
b) a glass fiber or an epoxy-based resin.

More specifically, the coating layer may be made from a coating composition in which a content of the trifunctional acrylate is 41% by weight or more and 69% by weight or less based on the total weight of the coating composition,
a content of the monofunctional acrylate and the bifunctional acrylate is 16% by weight or more and 30% by weight or less based on the total weight of the coating composition, and
a content of the glass fiber is 13% by weight or more and 29% by weight or less based on the total weight of the coating composition.

Alternatively, the coating layer may be made from a coating composition in which a content of the trifunctional acrylate is 10% by weight or more and 14% by weight or less based on the total weight of the coating composition,
a content of the monofunctional acrylate is 5% by weight or more and 7% by weight or less based on the total weight of the coating composition, and
the epoxy-based resin is contained in an amount of 4 to 5 times the total content of the trifunctional acrylate and the monofunctional acrylate.

Furthermore, the coating composition may further comprise an initiator and an additive, and the initiator may be a photo-initiator, or a mixture of a photo-initiator and a thermal initiator.

At this time, in the coating composition, a total content of the initiator may be 1% by weight or more and 4% by weight or less based on the total weight of the coating composition, wherein the photo-initiator may be contained in an amount of 30% by weight to 100% by weight based on the total weight of the initiator, and a content of the additive may be 0.1% by weight or more and 1% by weight or less based on the total weight of the coating composition.

A deviation of the degree of curling of the single-sided electrode including such a coating layer may be 0 mm or more and 5 mm or less.

According to another embodiment of the present disclosure, there is provided an electrode assembly comprising the above-mentioned single-sided electrode, wherein the electrode assembly is configured such that a double-sided cathode, a double-sided anode, and a separator interposed between the double-sided cathode and the double-sided anode are repeatedly laminated, wherein the single-sided electrode is disposed via the separator so that the double-sided anode or the double-sided cathode located in at least one of the uppermost and lowermost stages of the electrode assembly and the active material layer of the single-sided electrode face each other, wherein the double-sided cathode is configured such that a cathode active material layer is located on both surfaces of the cathode current collector, respectively, and wherein the double-sided anode is configured such that anode active material layer is located on both surfaces of an anode current collector, respectively.

Wherein, the single-sided electrode may have a polarity opposite to that of the double-sided anode or the double-sided cathode having a separator interposed therebetween.

According to yet another embodiment of the present disclosure, there is provided a single-sided electrode manufacturing apparatus which manufactures the above-mentioned single-sided electrode, the apparatus comprising: a supply roller that supplies an electrode current collector; a first coating device that applies an active material composition to one surface of the electrode current collector to form an active material layer on one surface of the electrode current collector; and a second coating device that applies the coating composition to the other surface of the electrode current collector to form a coating layer on the other surface of the electrode current collector.

The electrode current collector, which is formed with the active material layer supplied from the first coating device, may be dried.

The single-sided electrode manufacturing apparatus may further comprise a pair of rolling rollers that roll the upper and lower surfaces of the electrode current collector on which the dried active material layer is formed.

The coating layer of the electrode current collector supplied from the second coating device may be primarily cured by irradiation of ultraviolet (UV).

At this time, the irradiation dose of the ultraviolet (UV) may be 0.5 J/cm² or more and 1 J/cm² or less.

Furthermore, the single-sided electrode manufacturing apparatus may further comprise a heat treatment device in which the primarily cured coating layer is subjected to additional heat treatment and secondarily cured.

At this time, the additional heat treatment may be performed at 100 to 150° C. for 10 minutes to 30 minutes or less.

### BRIEF DESCRIPTION OF THE DRAWINGS

FIG. 1 is a diagram showing a single-sided electrode according to one embodiment of the present disclosure;

FIG. 2 is a diagram showing an electrode assembly according to another embodiment of the present disclosure;

FIG. 3 is a diagram showing an electrode assembly according to Comparative Example;

FIG. 4 is a diagram showing an apparatus for manufacturing a single-sided electrode according to another embodiment of the present disclosure; and

FIG. 5 is a diagram showing measurement of the degree of curling in Experimental Example.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

FIG. 1 is a diagram showing a single-sided electrode according to one embodiment of the present disclosure.

Referring to FIG. 1, the single-sided electrode 101 according to one embodiment of the present disclosure includes an electrode current collector 110; an active material layer 150 located on one surface of the electrode current collector 110; and a coating layer 180 located on the other surface of the electrode current collector 110.

Here, the single-sided electrode 101 may refer to an electrode in which the active material layer 150 is formed on only one surface among both surfaces of the electrode current collector 110. Also, the single-sided electrode 101 may be a single-sided cathode or a single-sided anode.

In one example, when the single-sided electrode 101 is a single-sided cathode, the electrode current collector 110 may be a cathode current collector, and the active material layer 150 may be a cathode active material layer. In another example, when the single-sided electrode 101 is a single-sided anode, the electrode current collector 110 may be an anode current collector, and the active material layer 150 may be an anode active material layer.

Below, the single-sided electrode 101 will be described as a single-sided cathode, but is not limited thereto, and the single-sided anode can also be described similarly.

The thickness of the coating layer 180 formed to exhibit the effects of the present disclosure is smaller than the thickness of the active material layer 150. Specifically, the thickness of the coating layer 180 may be 26% or more and 49% or less relative to the thickness of the active material layer 150. More specifically, the thickness of the coating layer 180 may be 25% or more and 45% or less relative to the thickness of the active material layer 150. Most specifically, the thickness of the coating layer 180 may be 30% or more and 40% or less relative to the thickness of the active material layer 150.

Thereby, the thickness of the coating layer 180 included in the single-sided electrode 101 has a thickness within the above-mentioned range, so that the degree of curling of the single-sided electrode 101 can be appropriately controlled, and also the single-sided electrode 101 can be easily stacked together with other cathodes and anodes in an electrode assembly unit.

Unlike the same, when the thickness of the coating layer 180 included in the single-sided electrode 101 is too large or small beyond the above-mentioned range, the degree of curling of the single-sided electrode 101 becomes excessive, which causes a problem that it is impossible to stack together with other cathode and anodes in an electrode assembly unit.

Here, the coating layer 180 may be made from a coating composition which comprises a) at least one acrylate selected from the group consisting of a monofunctional acrylate, a bifunctional acrylate, and a trifunctional acrylate, and b) a glass fiber or an epoxy-based resin.

In one example, the monofunctional acrylate and the bifunctional acrylate may be at least one material selected from the group consisting of HDDA (Hexanediol Diacrylate), 2-HEA (2-hydroxyethyl acrylate), 9-EGDA (Ethylene Glycol Diacetate), TTEGDA (Tetra (Ethylene Glycol) Diacrylate), and IOA (Isooctyl Acrylate). However, the monofunctional acrylate and the bifunctional acrylate are not limited thereto, and other monofunctional and/or bifunctional acrylates that can be used in secondary batteries known in the art can also be included in the present embodiment.

In one example, the trifunctional acrylate may be at least one material selected from the group consisting of TMPTA (trimethylolpropane triacrylate) and PETA (pentaerythritol triacrylate). However, the trifunctional acrylate is not limited thereto, and other trifunctional acrylates that can be used in secondary batteries known in the art can also be included in the present embodiment.

In one example, the glass fiber may be CRC (cellulose fiber reinforced cement)-12. However, the glass fibers are not limited thereto, and other glass fibers that can be used in secondary batteries known in the art can also be included in the present embodiment.

In one example, the epoxy-based resin may be one or more materials selected from the group consisting of a trifunctional epoxy composite resin having an epoxy equivalent of 135 to 150 g/eq, and (3′,4′-epoxycyclohexane)methyl 3,4-epoxycyclohexylcarboxylate. Specifically, YH-300 (Kukdo Chemical) can be used as the trifunctional epoxy composite resin, and Celloxide 2021P (Daicel) can be used as the (3′,4′-epoxycyclohexane)methyl 3,4-epoxycyclohexylcarboxylate. However, the epoxy-based resin is not limited thereto, and other epoxy-based resins that can be used in secondary batteries known in the art can also be included in the present embodiment.

More specifically, in one example, the coating layer may be made from a coating composition which comprises the trifunctional acrylate in an amount of 41% by weight or more and 69% by weight or less based on the total weight of the coating composition, and the monofunctional acrylate and the bifunctional acrylate in an amount of 16% by weight or more and 30% by weight or less based on the total weight of the coating composition.

Specifically, the content of the trifunctional acrylate may be 43% by weight or more and 65% by weight or less based on the total weight of the coating composition, and the content of the monofunctional acrylate and the bifunctional acrylate may be 16% by weight or more and 29% by weight or less based on the total weight of the coating composition. In one example, the content of the trifunctional acrylate may be 45% by weight or more and 60% by weight or less based on the total weight of the coating composition, and the content of the monofunctional acrylate and the bifunctional acrylate may be 18% by weight or more and 28% by weight or less based on the total weight of the coating composition.

Accordingly, in the coating composition, the contents of the trifunctional acrylate, the monofunctional acrylate and the bifunctional acrylate are included within the above range, so that the degree of curling of the single-sided electrode 101 including the coating layer 180 made from the coating composition can be appropriately controlled, and also the single-sided electrode 101 can be easily stacked together with other cathodes and anodes in an electrode assembly unit.

Unlike the same, in the coating composition, when the content of the trifunctional acrylate, the monofunctional acrylate and the bifunctional acrylate is included in an excessively large or small amount outside the above-described range, there is a problem that the degree of curling of the single-sided electrode 101 including the coating layer 180 made from the coating composition becomes excessive, which makes it impossible to stack together with other cathodes and anodes in an electrode assembly unit.

In the coating composition, the content of the glass fiber may be 13% by weight or more and 29% by weight or less based on the total weight of the coating composition. Specifically, the content of the glass fiber may be 14% by weight or more and 28% by weight or less based on the total weight of the coating composition. In one example, the content of the glass fiber may be 15% by weight or more and 27% by weight or less based on the total weight of the coating composition.

Thereby, in the coating composition, the content of the glass fiber is included within the above-mentioned range, so that the degree of curling of the single-sided electrode 101 including the coating layer 180 made from the coating composition can be appropriately controlled, and also the single-sided electrode 101 can be easily stacked together with other cathodes and anodes in an electrode assembly unit.

Unlike the same, in the coating composition, when the content of the glass fibers is included in an excessively large or small amount outside the above-mentioned range, there is a problem that the degree of curling of the single-sided electrode 101 including the coating layer 180 made from the coating composition becomes excessive, making it impossible to stack together with other cathodes and anodes in an electrode assembly unit.

Meanwhile, in another example, the coating layer may be made from a coating composition in which a content of the trifunctional acrylate is 10% by weight or more and 14% by weight or less based on the total weight of the coating composition, a content of the monofunctional acrylate is 5% by weight or more and 7% by weight or less based on the total weight of the coating composition, and the epoxy-based resin is contained in an amount of 4 to 5 times the total content of the trifunctional acrylate and the monofunctional acrylate.

Specifically, the content of the trifunctional acrylate is 10% by weight or more and 12% by weight or less based on the total weight of the coating composition, the content of the monofunctional acrylate may be 6% by weight or more and 7% by weight or less based on the total weight of the coating composition, and the epoxy-based resin may be contained in an amount of about 5 times the total content of the trifunctional acrylate and the monofunctional acrylate.

Thereby, in the coating composition, the ratio of the content of the trifunctional acrylate, the monofunctional acrylate, and the bifunctional acrylate, and the content of the epoxy resin is included within the above-mentioned range, so that the degree of curling of the single-sided electrode 101 including the coating layer 180 made from the coating composition can be appropriately controlled, and also the single-sided electrode 101 can be easily stacked together with other anodes and cathodes in an electrode assembly unit.

Unlike the same, in the coating composition, when the content of the trifunctional acrylate and the monofunctional acrylate is outside the above-mentioned range, or the content ratio of the epoxy-based resin is excessively large or small, there is a problem that the degree of curling of the single-sided electrode 101 including the coating layer 180 made from the coating composition becomes excessive, making it impossible to stack together with other cathodes and anodes in the electrode assembly unit.

Further, in the coating layer 180, the coating composition may further include an initiator and an additive, wherein the initiator may be a photo-initiator or a mixture of a photo-initiator and a thermal initiator. Here, the additive may mean a leveling agent, a surfactant, and the like.

In one example, the photo-initiator may be Darocur TPO (Diphenyl (2,4,6-trimethylbenzoyl)-phosphine oxide). However, the photo-initiator is not limited thereto, and other commonly used photo-initiators can also be included in the present embodiment.

The thermal initiator may be, for example, SI-110L (Sanshin Chemical). However, the thermal initiator is not limited thereto, and other commonly used thermal initiators can also be included in the present embodiment.

In one example, the additive may be at least one material selected from the group consisting of RS-75 (DIC Company) and F477 (DIC Company). However, the additive is not limited thereto, and other commonly used additives can also be included in the present embodiment.

In the coating composition, the total content of the initiator may be 1% by weight or more and 4% by weight or less based on the total weight of the coating composition, and the content of the additive may be 0.1% by weight or more and 1% by weight or less based on the total weight of the coating composition. More specifically, the total content of the initiator is 1.5% by weight or more and 3% by weight or less based on the total weight of the coating composition, wherein the photo-initiator can be contained in an amount of 30% to 100% by weight based on the total weight of the initiator.

Thereby, in the coating composition, the content of the initiator and the additive is included within the above-mentioned range, so that the degree of curling of the single-sided electrode 101 including the coating layer 180 made from the coating composition can be appropriately controlled, and also the single-sided electrode 101 can be easily stacked together with other cathodes and anodes in an electrode assembly unit.

Unlike the same, in the coating composition, when the content of the initiator and the additive is included in an excessively large or small amount outside the above-mentioned range, there is a problem that the degree of curling of the single-sided electrode 101 including the coating layer 180 made from the coating composition becomes excessive, making it impossible to stack together with other cathodes and anodes in an electrode assembly unit.

The deviation of the degree of curling of the single-sided electrode 101 manufactured as described above may be 0 mm or more and 5 mm or less. Specifically, the deviation of the degree of curling of the single-sided electrode 101 may be 0 mm or more and 4.5 mm or less. In one example, the deviation of the degree of curling of the single-sided electrode 101 may be 0 mm or more and 4 mm or less, and most specifically, 0 mm to 3 mm.

Thereby, the degree of curling of the single-sided electrode 101 has a deviation within the above range and thus, can be easily stacked together with other cathodes and anodes in an electrode assembly unit.

Unlike the same, when the degree of curling of the single-sided electrode 101 is outside the above-mentioned range and has an excessively large deviation, there is a problem that it is impossible to stack together with other cathodes and anodes in the electrode assembly unit.

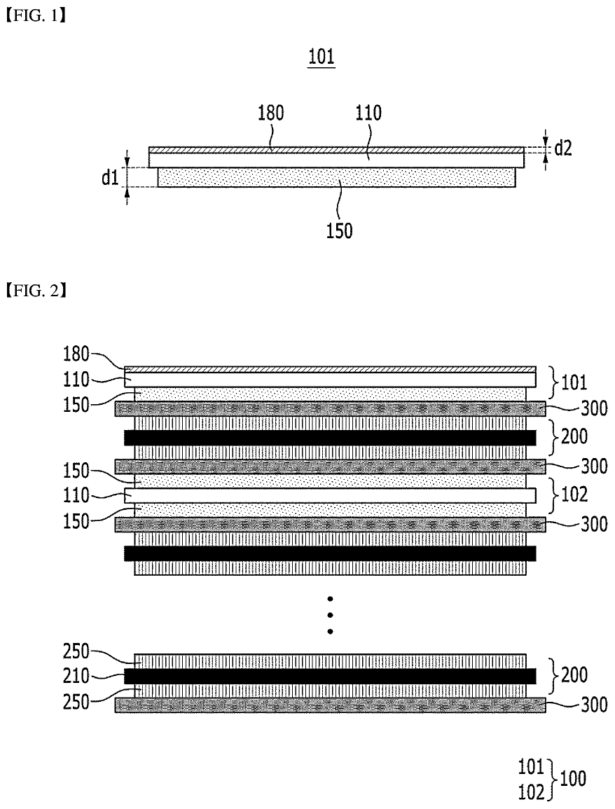

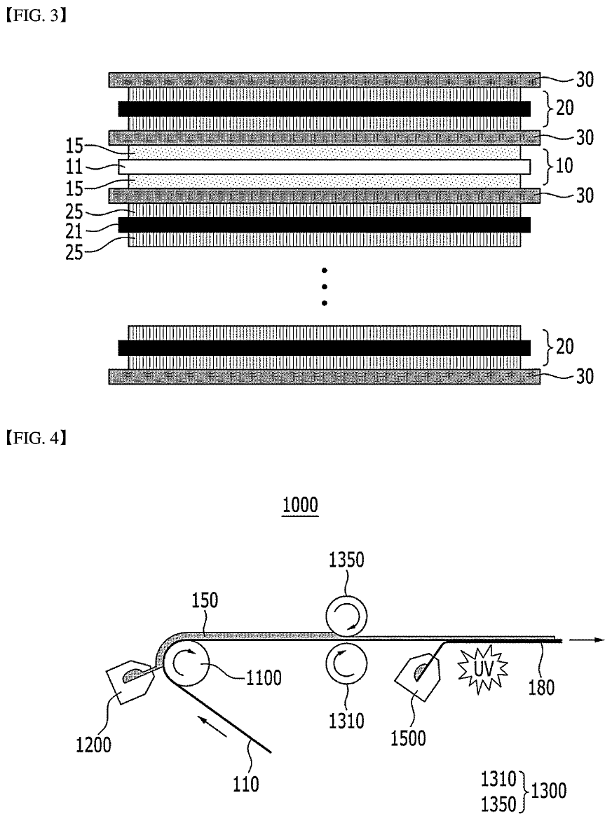

FIG. 2 is a diagram showing an electrode assembly according to another embodiment of the present disclosure.

Referring to FIG. 2, an electrode assembly according to another embodiment of the present disclosure includes a single-sided electrode 101. More specifically, the electrode assembly may be configured such that the double-sided cathode 102, the double-sided anode 200, and the separator 300 interposed between the double-sided cathode 102 and the double-sided anode 200 are repeatedly stacked. Here, the double-sided cathode 102 is configured such that cathode material layers 150 are located on both surfaces of the cathode current collector 110, and the double-sided anode electrode 200 is configured such that anode active material layers 250 are respectively located on both sides of the anode current collector 210.

The cathode current collector 110 is not particularly limited as long as it has conductivity without causing a chemical change in the battery. For example, stainless steel, aluminum, nickel, titanium, sintered carbon, and a material formed by surface-treating a surface of aluminum or stainless steel with carbon, nickel, titanium, silver, or the like can be used.

The cathode active material layer 150 can be manufactured in a form in which a cathode slurry containing a cathode active material is attached or applied onto the cathode current collector 110, and the cathode slurry may further include a conductive material and a polymer material in addition to the cathode active material.

The cathode active material may include, for example, lithium cobalt oxide (LiCoO₂), lithium nickel oxide (LiNiO₂); lithium manganese oxide; lithium copper oxide (Li₂CuO₂); vanadium oxide; a Ni-site type lithium nickel oxide; lithium manganese composite oxide; lithium manganese composite oxide with a spinel structure; LiMn₂O₄ in which a part of Li in the chemical formula is substituted with an alkaline earth metal ion; a disulfide compound; Fe₂(MoO₄)₃ and the like.

The anode current collector 210 is not particularly limited as long as it has high conductivity without causing a chemical change in the battery. For example, copper, stainless steel, aluminum, nickel, titanium, calcined carbon, a material formed by surface-treating a surface of copper or stainless steel with carbon, nickel, titanium, silver, or the like, aluminum-cadmium alloy, and the like can be used.

The anode active material layer 250 can be manufactured in a form in which an anode slurry containing an anode active material is attached or applied onto the anode current collector 210, and the anode slurry may further include a conductive material and a polymer material in addition to the anode active material.

As the anode active material, a common anode active material for lithium secondary batteries in the art may be used. In one example, a material such as lithium metal, lithium alloy, petroleum cork, activated carbon, graphite, silicon, tin, metal oxide or other carbons can be used.

The separator 300 separates the double-sided cathode 102 and the double-sided anode 200, the single-sided electrode 101 and the double-sided anode 200 or cathode 102, respectively, and provides a moving passage of lithium ions. Any separator can be used without particular limitation as long as it is generally used as a separator in a lithium secondary battery. Particularly, it is preferable that the separator has a low resistance against the ion migration of the electrolyte and has an excellent ability to impregnate the electrolyte.

Here, the single-sided electrode 101 may be located at the uppermost stage or the lowermost stage of the electrode assembly. More specifically, the single-sided electrode 101 may be disposed with the separator 300 interposed therebetween so that a double-sided anode 200 or a double-sided cathode 102 located on at least one of the uppermost and lowermost stages of the electrode assembly and the active material layer of the single-sided electrode 101 faces each other.

In one example, as shown in FIG. 2, the single-sided electrode 101 may be disposed at a position where the separator 300 is interposed therebetween so that the double-sided anode 200 located at the uppermost stage of the electrode assembly and the active material layer face each other. However, the present disclosure is not limited thereto, and the single-sided electrode 101 may be disposed at a position where the separator 300 is interposed therebetween so that the double-sided anode 200 or the double-sided cathode 102 located at the lowermost stage of the electrode assembly and the active material layer face each other.

Further, as shown in FIG. 2, the single-sided electrode 101 may be disposed in a direction in which the active material layer 150 included in the single-sided electrode 101 is in contact with the inner separator 300.

Moreover, the single-sided electrode 101 may have a polarity opposite to that of the double-sided anode 200 or the double-sided cathode 102 having a separator 300 interposed therebetween. More specifically, as shown in FIG. 2, when the single-sided electrode 101 is a single-sided cathode, the single-sided electrode 101 may be disposed at a position interposed between the double-sided cathode 200 and the separator 300 located on at least one of the uppermost and lowermost stages of the electrode assembly. Conversely, when the single-sided electrode 101 is a single-sided anode, the single-sided electrode 101 may be disposed at a position interposed between the double-sided cathode 102 and the separator 300 located on at least one of the uppermost and lowermost stages of the electrode assembly.

Further, although not shown in FIG. 2, a separator 300 in contact with the coating layer 180 of the single-sided electrode 101 located at the uppermost and/or lowermost stages of the electrode assembly may be further included.

Thereby, the electrode assembly according to the present embodiment is configured such that the single-sided electrode 101 is disposed at the uppermost and/or lowermost stages of the electrode assembly, thereby capable of securing cell safety while increasing the energy density of the electrode assembly compared to the prior art.

FIG. 3 is a diagram showing an electrode assembly according to Comparative Example.

Referring to FIG. 3, the electrode assembly according to Comparative Example is configured such that a double-sided cathode 10, a double-sided anode 20, and a separator 30 interposed between the double-sided cathode 10 and the double-sided anode 20 are repeatedly laminated. At this time, in the double-sided anode 20 at the uppermost and lowermost stages of the electrode assembly, the outermost active material layer does not participate in the reaction. Thereby, as the double-sided anode 20 is disposed at the uppermost and lowermost stages of the electrode assembly, the cell safety can be secured, but the corresponding double-sided anodes 20 do not participate in the reaction, which causes a problem that the energy density of the electrode assembly is lowered.

Unlike the same, the electrode assembly according to the present embodiment is configured such that the single-sided electrode 101 is disposed at the uppermost and/or lowermost stages of the electrode assembly as described above, thereby capable of securing the cell safety while increasing the energy density of the electrode assembly compared to the prior art.

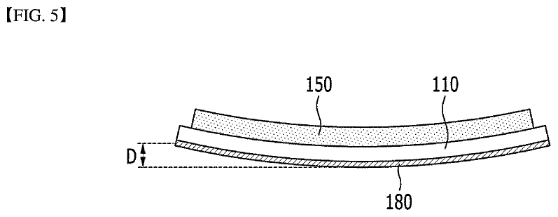

FIG. 4 is a diagram showing an apparatus for manufacturing a single-sided electrode according to another embodiment of the present disclosure.

Referring to FIG. 4, the single-sided electrode manufacturing apparatus 1000 according to another embodiment of the present disclosure is a single-sided electrode manufacturing apparatus that manufactures the single-sided electrode 101. More specifically, the single-sided electrode manufacturing apparatus 1000 according to the present embodiment includes a supply roller 1100 that supplies an electrode current collector 110; a first coating device 1200 that applies an active material composition to one surface of the electrode current collector 110 to form an active material layer 150 on one surface of the electrode current collector 110; and a second coating device 1500 that applies the coating composition to the other surface of the electrode current collector 110 to form a coating layer 180 on the other surface of the electrode current collector 110.

Further, in the single-sided electrode manufacturing apparatus 1000 according to the present embodiment, the electrode current collector 110 formed with the active material layer 150 supplied from the first coating device 1200 may be dried. Here, the single-sided electrode manufacturing apparatus 1000 according to the present embodiment may further include a separate drying device adjacent to the first coating device 1200.

In addition, the single-sided electrode manufacturing apparatus 1000 according to the present embodiment may further include a pair of rolling rollers 1300 that roll the upper and lower surfaces of the electrode current collector 110 on which the dried active material layer 150 is formed. More specifically, the pair of rolling rollers 1300 may include a first rolling roller 1310 located adjacent to the lower portion of the electrode current collector 110 and a second rolling roller 1350 located adjacent to an upper portion of the electrode current collector 110. Here, the first rolling roller 1310 and the second rolling roller 1350 may be disposed in a vertical direction with respect to the electrode current collector 110.

Further, in the single-sided electrode manufacturing apparatus 1000 according to the present embodiment, the coating layer 180 of the electrode current collector 110 supplied from the second coating device 1500 may be primarily cured by irradiation of ultraviolet (UV). In one example, the ultraviolet (UV) may be irradiated by a light source such as an H-bulb. Here, the irradiation dose of the ultraviolet (UV) may be 0.5 J/cm² or more and 1 J/cm² or less.

If the irradiation dose is too larger outside the above range, problems such as cracks in the coating layer may occur due to excessive curing. Conversely, if the irradiation dose is too small, there is a problem that curing cannot be performed well, and thus, the mechanical properties of the coating layer are deteriorated, which is not preferable.

With the configuration described above, the cross-sectional electrode manufacturing apparatus 1000 according to the present embodiment can easily manufacture the single-sided electrode 101 whose degree of curling is controlled.

In addition, although not shown in the figure, the single-sided electrode manufacturing apparatus 1000 may further comprise a heat treatment device in which the primarily cured coating layer 180 is subjected to additional heat treatment and secondarily cured.

If the additional heat treatment is performed, not only a flat single-sided electrode with less curling can be manufactured, but also the interfacial adhesive strength between the coating layer 180 and the electrode current collector 110 can be improved.

At this time, the additional heat treatment may be performed at 100 to 150° C. for 10 to 30 minutes or less.

If the heat treatment is performed at the very high temperature or for too long a time outside the above range, it is not effective for curl control, and cracks in the coating layer may occur. Conversely, if the heat treatment is performed at the very low a temperature or for too short a time, the effect due to heat treatment cannot be obtained sufficiently, which is not preferable.

Further, heat treatment is more preferably performed after the primary curing using UV as described above. When heat treatment is performed first, it is difficult to control the curling by UV irradiation, which is performed later, whereas when heat treatment is performed after UV irradiation, the portion where shrinkage in the direction of the coating layer by UV can be alleviated by heat treatment, which makes it easy to control curling.

Hereinafter, the subject matter of the present disclosure will be described with reference to more specific examples. The following examples are for illustrative purposes only and are not intended to limit the scope of the present disclosure.

### Example 1

A single-sided cathode was manufactured in which a cathode active material layer having a thickness of 60 um was formed on the upper surface of the aluminum (Al) foil, which is a cathode current collector with a size of 10 cm*10 cm and a thickness of 15 um, and a coating layer having a thickness of 20 um was formed on the lower surface of the aluminum foil.

Here, the cathode active material layer was made from a cathode active material slurry obtained by using LiNi_{0.6}Mn_{0.2}Co_{0.2}O₂ as a cathode active material, carbon black as a conductive material, and polyvinylidene fluoride (PVdf) as a binder, respectively, and adding an NMP solvent to a mixture of cathode active material:conductive material:binder in a weight ratio of 96:2:2. In addition, in the single-sided cathode, the cathode active material layer was prepared by applying the cathode active material slurry onto an upper surface of an aluminum foil, followed by drying and rolling.

Further, the coating layer was made from a coating solution obtained by using Miramer M320 (TMPTA) (Miwon Specialty Chemical) as a trifunctional acrylate, Miramer M200 (HDDA) as a mono/bifunctional acrylate, CRC-12 (glass frit) as glass fiber, Darocur TPO (BASF) as a photo-initiator, and F-477 (DIC) as an additive (leveling agent), respectively, and mixing trifunctional acrylate:monofunctional/bifunctional acrylate:glass fiber:photo-initiator:additive in a weight ratio of 50:25:20:5:0.1 or less. In addition, in the single-sided cathode, the coating layer was prepared by applying the coating solution to the lower surface of aluminum foil, followed by UV curing (0.5 J/cm²).

### Example 2

A single-sided cathode was manufactured in the same manner as in Example 1, except that in Example 1, the thickness of the coating layer was 25 um.

### Example 3

A single-sided cathode was manufactured in the same manner as in Example 1, except that in Example 1, a coating solution made by using Miramer M2770 (TTEGDA) as mono/bifunctional acrylate, and RS-75 (DIC) as an additive (leveling agent), and mixing trifunctional acrylate:monofunctional/bifunctional acrylate:glass fiber:photo-initiator:additive in a weight ratio of 50:27:20:2.9:0.1 was used, wherein the thickness of the coating layer had a thickness of 25 um.

### Example 4

A single-sided cathode was manufactured in the same manner as in Example 3, except that in Example 3, a coating solution made by mixing trifunctional acrylate:monofunctional/bifunctional acrylate:glass fiber:photo-initiator:additive in a weight ratio of 60:22:15:2.9:0.1 was used.

### Example 5

A single-sided cathode was manufactured in the same manner as in Example 3, except that in Example 3, a coating solution made by mixing trifunctional acrylate:monofunctional/bifunctional acrylate:glass fiber:photo-initiator:additive in a weight ratio of 60:17:20:2.9:0.1 was used.

### Comparative Example 1

A single-sided cathode was manufactured in the same manner as in Example 1, except that in Example 1, the coating layer was not formed.

### Example 6

A single-sided cathode was manufactured in the same manner as in Example 1, except that in Example 1, the thickness of the coating layer was 15 um.

### Example 7

A single-sided cathode was manufactured in the same manner as in Example 1, except that in Example 1, the thickness of the coating layer was 30 um.

### Example 8

A single-sided cathode was manufactured in the same manner as in Example 1, except that in Example 1, the thickness of the coating layer was 35 um.

### Example 9

A single-sided cathode was manufactured in the same manner as in Example 3, except that in Example 3, a coating solution made by mixing trifunctional acrylate:monofunctional/bifunctional acrylate:glass fiber:photo-initiator:additive in a weight ratio of 60:30:7:2.9:0.1 was used.

### Example 10

A single-sided cathode was manufactured in the same manner as in Example 3, except that in Example 3, a coating solution made by mixing trifunctional acrylate:monofunctional/bifunctional acrylate:glass fiber:photo-initiator:additive in a weight ratio of 50:32:15:2.9:0.1 was used.

### Example 11

A single-sided cathode was manufactured in the same manner as in Example 3, except that in Example 3, a coating solution made by mixing trifunctional acrylate:monofunctional/bifunctional acrylate:glass fiber:photo-initiator:additive in a weight ratio of 70:15:12:2.9:0.1 was used.

### Example 12

A single-sided cathode was manufactured in the same manner as in Example 3, except that in Example 3, a coating solution made by using Miramer M1084 (IOA) as a mono/bifunctional acrylate, and mixing trifunctional acrylate:mono/bifunctional acrylate:glass fiber:photo-initiator:additive in a weight ratio of 40:40:17:2.9:0.1 was used.

### Example 13

A single-sided cathode was manufactured in the same manner as in Example 3, except that in Example 3, a coating solution made by mixing trifunctional acrylate:mono/bifunctional acrylate:glass fiber:photo-initiator:additive in a weight ratio of 50:22:25:2.9:0.1 was used.

### Example 14

A single-sided cathode was manufactured in the same manner as in Example 3, except that in Example 3, a coating solution made by mixing trifunctional acrylate:mono/bifunctional acrylate:glass fiber:photo-initiator:additive in a weight ratio of 35:42:20:2.9:0.1 was used.

### Experimental Example 1 (Measurement of Degree of Curling, Pencil Hardness, and Permeability According to the Thickness of the Coating Layer)

For the manufactured Example 1, Example 2, Examples 6 to 8, and Comparative Example 1, the degree of curling and pencil hardness according to the thickness of the coating layer were measured, respectively.

For the measurement of the degree of curling, as shown in FIG. 5, the degree of bending in the (+) or (−) direction with respect to the electrode was determined by measuring the distance (D) between each corner of the single-sided cathode from the bottom surface, and then calculating the average value, and the results are shown in Table 1 below.

Pencil hardness was evaluated according to the Japanese Standard JIS K 5400. In this regard, a pencil hardness meter was reciprocated three times on the coating layer under a load of 0.5 kg to determine the hardness at which no scratches appeared. The results are shown in Table 1 below.

TABLE 1

| | Thickness of coating | Degree of | Pencil |
|---|---|---|---|
| | layer (um) | curling (mm) | hardness |
| Example 1 | 20 | −0.9 | 3~4H |
| Example 2 | 25 | 1.2 | 5H |
| Comparative | — | −24.8 | <4B |
| Example 1 | | | |
| Example 6 | 15 | −10.4 | 1H |
| Example 7 | 30 | 6.4 | 5H |
| Example 8 | 35 | 9.9 | 6H |

Referring to Table 1, Examples 1 to 2 and 6 to 8 and Comparative Example 1 include coating layers having the same composition, but differ only in the thickness of each coating layer. At this time, when the thickness of the coating layer is 20 um and 25 um as in Examples 1 and 2, it can be confirmed that the degree of curling is measured as −0.9 and 1.2, respectively. That is, in the case of a single-sided cathode having the thickness of the coating layer as in Examples 1 and 2, it can be confirmed that the degree of curling is the smallest and the pencil hardness is excellent.

Unlike the same, when there is no coating layer as in Comparative Example 1, it can be confirmed that the degree of curling is very large as −24.8, and the pencil hardness is also very poor.

On the other hand, it can be confirmed that even when the thickness of the coating layer is 15 um as in Example 6, it is superior to the case where there is no coating layer, but the degree of curling is measured as −10.4, and the pencil hardness is 1H, and in the case of a single-sided cathode having a thinner coating layer than Examples 1 and 2, the degree of curling is relatively large, and the pencil hardness is also relatively poor.

In addition, it can be confirmed that when the thickness of the coating layer is 30 um and 35 um, respectively, as in Examples 7 and 8, the decree of curling is measured as 6.4 and 9.9, respectively. That is, in the case of a single-sided cathode having a thicker coating layer than Examples 1 and 2, as in Examples 8 and 9, the pencil hardness is excellent, but on the contrary, curling occurs and the degree of curling is relatively large.

Therefore, it can be confirmed that it is more important to set an appropriate thickness of the coating layer.

### Example 15 (about 4 Times)

A single-sided cathode was manufactured in which a cathode active material layer having a thickness of 75 um was formed on the upper surface of the aluminum (Al) foil, which is a cathode current collector with a size of 10 cm*10 cm and a thickness of 15 um, and a coating layer having a thickness of 30 um was formed on the lower surface of the aluminum foil.

Here, the cathode active material layer was made from a cathode active material slurry obtained by using LiNi_{0.6}Mn_{0.2}Co_{0.2}O₂ as a cathode active material, carbon black as a conductive material, and polyvinylidene fluoride (PVdf) as a binder, respectively, and adding an NMP solvent to a mixture of cathode active material:conductive material:binder in a weight ratio of 96:2:2. In addition, in the single-sided cathode, the cathode active material layer was prepared by applying the cathode active material slurry onto an upper surface of an aluminum foil, followed by drying and rolling.

Further, the coating layer was made from a coating solution obtained by using pentaerythritol tetraacrylate (PETA) (Miwon Specialty Chemical) as a trifunctional acrylate, 2-Hydroxy Ethlyacrylate (2-HEA) (Miwon Specialty Chemical) as a monofunctional acrylate, YH-300 (Kukdo Chemical) and Celloxide 2021P (Daicel) as an epoxy resin, Darocur TPO (BASF) as a photo-initiator, SI-110L (Sanshin Chemical) as a thermal initiator, and F-477 (DIC) as an additive (surfactant), respectively, and mixing trifunctional acrylate:monofunctional acrylate:epoxy resin 1:epoxy resin 2:photo-initiator:thermal initiator:additive in a weight ratio of 12:7:25:53:1.0:1.0:1.0. In addition, in the single-sided cathode, the coating layer was prepared by applying the coating solution to the lower surface of aluminum foil, followed by UV curing (0.5 J/cm²) and heat treatment (120° C., 30 min).

### Example 16 (about 5 Times)

A single-sided positive electrode was manufactured in the same manner as in Example 15, except that in Example 15, a coating solution made by mixing trifunctional acrylate:monofunctional acrylate:epoxy-based resin 1:epoxy-based resin 2:photo-initiator:thermal initiator:additive in a weight ratio of 10:6:28:53:1.0:1.0:1.0 was used.

### Example 17 (about 2 Times)

A single-sided positive electrode was manufactured in the same manner as in Example 15, except that in Example 15, a coating solution made by mixing trifunctional acrylate:monofunctional acrylate:epoxy-based resin 1:epoxy-based resin 2:photo-initiator:thermal initiator:additive in a weight ratio of 20:14:21:42:1.0:1.0:1.0 was used.

### Example 18 (about 3 Times)

A single-sided positive electrode was manufactured in the same manner as in Example 15, except that in Example 15, a coating solution made by mixing trifunctional acrylate:monofunctional acrylate:epoxy-based resin 1:epoxy-based resin 2:photo-initiator:thermal initiator:additive in a weight ratio of 12:10:25:50:1.0:1.0:1.0 was used.

### Example 19 (about 6 Times)

A single-sided positive electrode was manufactured in the same manner as in Example 15, except that in Example 15, a coating solution made by mixing trifunctional acrylate:monofunctional acrylate:epoxy-based resin 1:epoxy-based resin 2:photo-initiator:thermal initiator:additive in a weight ratio of 9:5:27:57:0.5:1.0:0.5 was used.

### Example 20 (about 7 Times)

A single-sided positive electrode was manufactured in the same manner as in Example 15, except that in Example 15, a coating solution made by mixing trifunctional acrylate:monofunctional acrylate:epoxy-based resin 1:epoxy-based resin 2:photo-initiator:thermal initiator:additive in a weight ratio of 8:4:28:58:0.5:1.0:0.5 was used.

### Example 21 (about 7 Times)

A single-sided positive electrode was manufactured in the same manner as in Example 15, except that in Example 15, the epoxy-based resin was not used, a coating solution made by mixing trifunctional acrylate:monofunctional acrylate:photo-initiator:additive in a weight ratio of 64:32:3.0::1.0 was used, and only UV irradiation was performed without heat treatment.

### Example 22 (about 7 Times)

A single-sided positive electrode was manufactured in the same manner as in Example 15, except that in Example 15, the acrylate material was not used, a coating solution made by mixing epoxy-based resin 1:epoxy-based resin 2:thermal initiator:additives in a weight ratio of 33:65:1.0:1.0 was used, and only heat treatment was performed without UV irradiation.

### Experimental Example 2 (Measurement of Degree of Curling According to the Composition of the Coating Layer)

For the manufactured Examples 3 to 5 and Examples 9 to 22, the degree of curling and pencil hardness according to the composition of the coating layer were measured, respectively.

For the measurement of the degree of curling, as shown in FIG. 5, the degree of bending in the (+) or (−) direction with respect to the electrode was determined by measuring the distance (D) between each corner of the single-sided cathode from the bottom surface, and then calculating the average value, and the results are shown in Tables 2 and 3 below.

TABLE 2

| | Composition of coating layer (weight ratio) | | | | | | |
|---|---|---|---|---|---|---|---|
| | | Monofunctional/ | | | Photo- | | |
| | Trifunctional | bifunctional | | Glass | initiator | | |
| | acrylate | acrylate | | fiber | Darocur | Additive | Degree of |
| | TMPTA | TTEGDA | IOA | CRC-12 | TPO | RS-75 | curling (mm) |
| Example 3 | 50 | 27 | — | 20 | 2.9 | 0.1 | −1~1 |
| Example 4 | 60 | 22 | — | 15 | 2.9 | 0.1 | 1~3 |
| Example 5 | 60 | 17 | — | 20 | 2.9 | 0.1 | −2~3 |
| Example 9 | 60 | 30 | — | 7 | 2.9 | 0.1 | 17~18 |
| Example 10 | 50 | 32 | — | 15 | 2.9 | 0.1 | 7~9 |
| Example 11 | 70 | 15 | — | 12 | 2.9 | 0.1 | unmeasurable |
| Example 12 | 40 | — | 40 | 17 | 2.9 | 0.1 | 14~15 |
| Example 13 | 50 | 22 | — | 25 | 2.9 | 0.1 | unmeasurable |
| Example 14 | 35 | 42 | — | 20 | 2.9 | 0.1 | 16~18 |

TABLE 3

| | Composition of coating layer (weight ratio) | | | | | | | | |
|---|---|---|---|---|---|---|---|---|---|
| | | | Epoxy- | Epoxy- | | | | | |
| | | Monofunctional/ | based | based | Photo- | | | | Degree |
| | Trifunctional | bifunctional | resin | resin | initiator | Thermal | | Epoxy/ | of |
| | acrylate | acrylate | 1 | 2 | Darocur | initiator | Additive | acrylate | curling |
| | PETA | 2-HEA | YH-300 | Cel2021P | TPO | SI-110L | F-477 | ratio | (mm) |
| Example 15 | 12 | 7 | 25 | 53 | 1 | 1 | 1 | 4 times | −3~−1 |
| Example 16 | 10 | 6 | 28 | 53 | 1 | 1 | 1 | 5 times | −1~1 |
| Example 17 | 20 | 14 | 21 | 42 | 1 | 1 | 1 | 2 times | −20~−17 |
| Example 18 | 12 | 10 | 25 | 50 | 1 | 1 | 1 | 3 times | −12~−7 |
| Example 19 | 9 | 5 | 27 | 57 | 0.5 | 1 | 0.5 | 6 times | 7~11 |
| Example 20 | 8 | 4 | 28 | 58 | 0.5 | 1 | 0.5 | 7 times | >15 |
| Example 21 | 64 | 32 | — | — | 3 | — | 1 | — | <−25, crack |
| Example 22 | — | — | 33 | 65 | — | 1 | 1 | — | >15, delayed |
| | | | | | | | | | curing time |

Referring to Table 2, in the case of Examples 3 to 5 and 9 to 14, the compositions of respective coating layers are different while the thicknesses of the coating layer are identical to each other. At this time, in the case of a single-sided cathode having the same composition as in Examples 3 to 5, it can be confirmed that the degree of curling is measured as −1˜1 mm, 1˜3 mm, −2˜3 mm, −1˜1 mm, respectively. That is, in the case of the single-sided cathode having the composition of the coating layer as in Examples 3 to 6, it can be confirmed that the degree of curling is relatively small. Unlike the same, in the case of a single-sided cathode having the same composition as in Examples 9 to 14, it can be confirmed that the degree of curling is measured as 17˜18, 7˜9 (unmeasurable), 14˜15 (unmeasurable), and 16˜18, respectively.

Particularly, in the case of Example 9, it can be confirmed that the content of glass fibers is relatively small and thus, the degree of curling is relatively large. Unlike the same, in the case of Example 13, it can be confirmed that the content of glass fiber is relatively high, and the coating layer is not sufficiently cured by UV, which makes it difficult to measure the degree of curling. In this case, it is judged that additional heat treatment is performed and thus, secondary curing is required.

In addition, in the case of Examples 10 and 12, it can be confirmed that the content of monofunctional/bifunctional acrylate is relatively large, and thus, the degree of curling is relatively large compared to Examples 3 to 5.

Further, in the case of Example 11, it can be confirmed that the content of the trifunctional acrylate is relatively high, the adhesion between the coating layer and the current collector is insufficient, and the degree of curling is relatively large. Unlike the same, it can be confirmed that in the case of Example 14, the content of trifunctional acrylate is relatively small, and the degree of curling is relatively large compared to Examples 3 to 5.

Accordingly, in the case of including a coating layer having the same thickness as in Examples 3 to 5 and Examples 9 to 14, the degree of curling of the single-sided cathode including the coating layer having the same composition as in Examples 3 to 5 is relatively small, which may be easier to stack together with other cathodes and anodes in an electrode assembly unit.

On the other hand, referring to Table 3, in the case of Examples 15 to 20, the compositions of respective coating layers are different from each other while the thicknesses of the coating layers are identical to each other. Specifically, the weight ratio of acrylate and epoxy resin was varied. At this time, in the case of single-sided cathodes including the compositions of Examples 15 and 16 in which the weight ratio of acrylate and epoxy resin is 4 to 5 times, it can be confirmed that the degree of curling is measured as −3˜−1 mm and −1˜1 mm, respectively. That is, in the case of a single-sided cathode having the composition of the coating layer as in Examples 15 to 16, it can be confirmed that the degree of curling is relatively small.

In addition, in the case of single-sided cathodes including the compositions of Examples 17 and 18, in which the content of the epoxy-based resin is smaller than that of the acrylate, the degree of curling is −20˜−17 and −12˜−7, respectively, confirming that the degree of curling is relatively large.

Unlike the same, in the case of single-sided cathodes including the compositions of Examples 19 and 20 in which the content of epoxy-based resin is higher than that of acrylate, the degree of curling is 7˜11 and 15 or more, respectively, confirming that the degree of curling is relatively large, and there was a problem that a delay occurred in the actual curing time.

Therefore, when using acrylate and epoxy resin as the composition of the coating layer, it is preferable to mix the epoxy-based resin in a weight ratio of 4 to 5 times that of the acrylate. Furthermore, in the case of Example 22 containing only acrylate and also performing only UV irradiation, the degree of curling is very large, and cracks occur in the coating layer. In the case of Example 22 containing only epoxy resin and thus performing only heat treatment, the degree of curling is large and the curing time is delayed, which causes a problem that the application of roll-to-roll process is difficult and process time is increased.

Although preferred embodiments of the present disclosure have been shown and described above, the scope of the present disclosure is not limited thereto, and numerous changes and modifications can be devised by those skilled in the art using the principles of the invention defined in the appended claims, which also falls within the spirit and scope of the present disclosure.

### DESCRIPTION OF REFERENCE NUMERALS

100: cathode
101 single-sided cathode
110: electrode current collector
150: active material layer
180: coating layer
102 double-sided cathodes
200: anode
300: separator
1000: single-sided electrode manufacturing apparatus
1100: supply roller
1200: first coating device
1300: rolling roller
1500: second coating device

### INDUSTRIAL APPLICABILITY

According to embodiments, the present disclosure provides a single-sided electrode including a coating layer located on the other surface of an electrode current collector, wherein the thickness of the coating layer is formed smaller than the thickness of the active material layer, thereby capable of controlling curling of the single-sided electrode.

Moreover, by adjusting the composition of the coating layer, a single-sided electrode capable of more improved curl control can be provided.

Further, according to another embodiment, the present disclosure provides an electrode assembly in which the above-mentioned single-sided electrode is located at the uppermost and/or lowermost stages, thereby increasing energy density and securing cell stability.

Further, according to another embodiment, the present disclosure can provide a single-sided electrode manufacturing apparatus which forms a coating layer located on the other surface of an electrode current collector, thereby capable of controlling curling of the single-sided electrode.

Furthermore, by performing additional heat treatment as well as UV irradiation during formation of the coating layer, a single-sided electrode manufacturing apparatus capable of more improved curl control can be provided.

The effects of the present disclosure are not limited to the effects mentioned above and additional other effects not described above will be clearly understood from the description of the appended claims by those skilled in the art.

1. A single-sided electrode comprising:
an electrode current collector;
an active material layer located on a first surface of the electrode current collector; and
a coating layer located on a second surface of the electrode current collector opposite from the first surface,
wherein a thickness of the coating layer is smaller than a thickness of the active material layer.

2. The single-sided electrode of claim 1, wherein the thickness of the coating layer from 26% to 49% of the thickness of the active material layer.

3. The single-sided electrode of claim 1, wherein the coating layer is made from a coating composition which comprises:
a) at least one acrylate selected from a group consisting of: a monofunctional acrylate, a bifunctional acrylate, or a trifunctional acrylate; and
b) a glass fiber or an epoxy-based resin.

4. The single-sided electrode of claim 3, wherein the coating layer is made from a coating composition in which:
a content of the trifunctional acrylate is from 41% by weight to 69% by weight based on a total weight of the coating composition;
a content of the monofunctional acrylate and the bifunctional acrylate is from 16% by weight to 30% by weight based on the total weight of the coating composition; and
a content of the glass fiber is from 13% by weight to 29% by weight based on the total weight of the coating composition.

5. The single-sided electrode of claim 3, wherein: the coating layer is made from a coating composition in which:
a content of the trifunctional acrylate is from 10% by weight to 14% by weight based on a total weight of the coating composition;
a content of the monofunctional acrylate is from 5% by weight to 7% by weight based on the total weight of the coating composition; and
a content of the epoxy-based resin is 4 to 5 times by weight of a total of the content of the trifunctional acrylate and the content of the monofunctional acrylate.

6. The single-sided electrode of claim 3, wherein: the coating composition further comprises an initiator and an additive, and the initiator is a photo-initiator or a mixture of a photo-initiator and a thermal initiator.

7. The single-sided electrode of claim 6, wherein in the coating composition,
a content of the initiator is from 1% by weight to 4% by weight based on a total weight of the coating composition, wherein the photo-initiator is from 30% by weight to 100% by weight based on a total weight of the initiator, and
a content of the additive is from 0.1% by weight to 1% by weight based on the total weight of the coating composition.

8. The single-sided electrode of claim 1, wherein a deviation of a degree of curling of the single-sided electrode is from 0 mm to 5 mm.

9. An electrode assembly comprising:
the single-sided electrode of claim 1; and
a double-sided cathode, a double-sided anode, and a first separator interposed between the double-sided cathode and the double-sided anode laminated together,
wherein the single-sided electrode is disposed adjacent to a second separator so that the active material layer of the single-sided electrode faces the double-sided anode or the double-sided cathode,
wherein the double-sided cathode has cathode active material layers located on opposite surfaces of a cathode current collector, respectively, and
wherein the double-sided anode has anode active material layers located on opposite surfaces of an anode current collector, respectively.

10. The electrode assembly of claim 9, wherein the single-sided electrode has a polarity opposite to that of the double-sided anode or the double-sided cathode.

11. A manufacturing apparatus configured to assemble the single-sided electrode of claim 1, the manufacturing apparatus comprising:
a supply roller configured to supply the electrode current collector;
a first coating device configured to apply an active material composition to the first surface of the electrode current collector to form the active material layer on the first surface of the electrode current collector; and
a second coating device configured to apply a coating composition to the second surface of the electrode current collector to form the coating layer on the second surface of the electrode current collector.

12. The single-sided electrode manufacturing apparatus of claim 11, wherein the manufacturing apparatus is configured to dry the active material layer.

13. The single-sided electrode manufacturing apparatus of claim 12, further comprising a pair of rolling rollers that are configured to roll the first and second surfaces of the electrode current collector.

14. The single-sided electrode manufacturing apparatus of claim 11, further comprising a light source configured to primarily cure the coating layer of the electrode current collector by irradiation of ultraviolet (UV) light.

15. The single-sided electrode manufacturing apparatus of claim 14, wherein the light source is configured to provide an irradiation dose of the ultraviolet (UV) light from 0.5 J/cm² to 1 J/cm².

16. The single-sided electrode manufacturing apparatus of claim 14, further comprising a heat treatment device configured to provide heat treatment and a secondary curing to the coating layer.

17. The single-sided electrode manufacturing apparatus of claim 16, wherein the heat treatment device is configured to heat the coating layer to 100 to 150° C. for 10 minutes to 30 minutes.
